(19) United States
(12) Patent Application Publication
(10) Pub. No.: US 2015/0063261 A1
(43) Pub. Date: Mar. 5, 2015

(54) METHOD FOR TRANSMITTING AND RECEIVING VOICE PACKET AND ELECTRONIC DEVICE IMPLEMENTING THE SAME

(71) Applicant: Samsung Electronics Co., Ltd., Gyeonggi-do (KR)

(72) Inventor: Kwanghun Kim, Gyeonggi-do (KR)

(21) Appl. No.: 14/476,608

(22) Filed: Sep. 3, 2014

(30) Foreign Application Priority Data
Sep. 3, 2013 (KR) 10-2013-0105186

(51) Int. Cl. H04L 29/06; H04W 4/16; H04M 1/253

(52) U.S. Cl. CPC H04L 65/80; H04M 1/2535; H04W 4/16
USPC 370/329

(57) ABSTRACT

A method for enhancing the voice quality of received voice in VoLTE (Voice over Longterm Evolution) includes setting a call with another electronic device, performing a Tx voice enhancement process on first voice data received from a voice input unit, encoding the first voice data, and second voice data received from the voice input unit, following the first voice data, synthesizing the first voice data and the second data, and converting the synthesized voice data into a voice packet and transmitting the voice packet to another electronic device. Other electronic devices for voice packet transmission/reception are also disclosed.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0105186, filed on Sep. 3, 2013, which is hereby incorporated by reference for all purposes as if fully set forth herein.

### TECHNICAL FIELD

The present disclosure relates generally to voice packet transmission/reception method and device for enhancing the voice quality of received voice in VoLTE (Voice over Longterm Evolution).

### BACKGROUND

VoLTE, which is a voice transfer system of LTE, uses a packet switching system other than a circuit switching system of GSM and WCDMA. Differently from the circuit switching system that exchanges information at an exact time interval, in the packet switching system, network delay of a packet randomly occurs in a receiver. In a case of voice communication that should be real-time communication, when network delay of a packet occurs, voice quality can be deteriorated and packet loss may happen, causing the communication to be failed.

### SUMMARY

To address the above-discussed deficiencies, it is a primary object to provide a method of minimizing voice quality deterioration, packet loss, and communication failure due to network delay in an electronic device employing a voice packet switching system.

In accordance with an aspect of the present disclosure, a voice packet transmission method of an electronic device may include: an operation of setting a call with another electronic device; an operation of performing a Tx voice enhancement process on voice data received from a voice input unit; a first encoding operation of encoding the voice data, on which the Tx voice enhancement process has been performed, and voice data received from the voice input unit in a next time; a synthesizing operation of synthesizing the encoded two pieces of voice data with each other; and a first transmission operation of converting the synthesized voice data into a voice packet and transmitting the voice packet to the other electronic device.

In accordance with another aspect of the present disclosure, a method, in which an electronic device processes a voice packet received from another electronic device, may include: an operation of converting a first voice packet received from the other electronic device into voice data; an operation of dividing the converted voice data into first voice data on which a Tx voice enhancement process has been performed, and second voice data on which the Tx voice enhancement process has not been performed; an operation of decoding the first voice data and storing the second voice data in a buffer; a first output operation of outputting the decoded first voice data to a voice output unit; and a second output operation of outputting the second voice data stored in the buffer to the voice output unit when reception of a second voice packet is delayed after the first voice packet is received.

In accordance with another aspect of the present disclosure, an electronic device may include: a voice input/output unit; a wireless communication unit for transmitting/receiving a voice packet; and a processor for performing a voice data processing operation of processing voice data input from the voice input/output unit to a voice packet and transferring the voice packet to the wireless communication unit, and performing a voice packet processing operation of processing a voice packet input from the wireless communication unit to voice data and transferring the voice packet to the voice input/output unit, wherein the voice data processing operation may include: an operation of performing a Tx voice enhancement process on the voice data received from the voice input/output unit; a first encoding operation of encoding the voice data, on which the Tx voice enhancement process has been performed, and voice data received from the voice input/output unit in a next time; a synthesizing operation of synthesizing the encoded two pieces of voice data with each other; and a first transmission operation of controlling the wireless communication unit to convert the synthesized voice data into a voice packet and transmit the voice packet to another electronic device, wherein the voice packet processing operation may include: an operation of converting a first voice packet received from the wireless communication unit into voice data; an operation of dividing the converted voice data into first voice data on which a Tx voice enhancement process has been performed, and second voice data on which the Tx voice enhancement process has not been performed; an operation of decoding the first voice data and storing the second voice data in a buffer; a first output operation of outputting the decoded first voice data to the voice input/output unit; and a second output operation of outputting the second voice data stored in the buffer to the voice input/output unit when reception of a second voice packet is delayed after the first voice packet is received.

According to an embodiment of the present disclosure, packet delay due to a network environment organically changed is overcome, so that it is possible to provide a user with the best voice quality.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a conceptual diagram for describing a packet recovery operation according to an embodiment of the present disclosure;

FIG. 2 is a conceptual diagram for describing a packet recovery operation according to another embodiment of the present disclosure;

FIG. 3 is a network configuration diagram for describing a voice packet transmission/reception system according to an embodiment of the present disclosure;

FIG. 4 is a detailed block configuration diagram for a voice data processing circuitry according to an embodiment of the present disclosure;

FIG. 5 is a detailed block configuration diagram for a voice packet processing circuitry according to an embodiment of the present disclosure;

FIGS. 6A and 6B are diagrams illustrating configurations of voice packets according to embodiments of the present disclosure;

FIG. 7 is a flowchart for describing a voice data processing operation of a packet transmission device according to an embodiment of the present disclosure;

FIG. 8 is a flowchart for describing a voice packet processing operation of a packet reception device according to an embodiment of the present disclosure;

FIG. 9 is a flowchart for describing a synchronization operation of a TX voice enhancement processing scheme among communication terminals according to an embodiment of the present disclosure;

FIG. 10 is a flowchart for describing a voice data processing operation of a packet transmission device according to another embodiment of the present disclosure; and

FIG. 11 is a flowchart for describing a voice packet processing method of a packet reception device according to another embodiment of the present disclosure.

### DETAILED DESCRIPTION

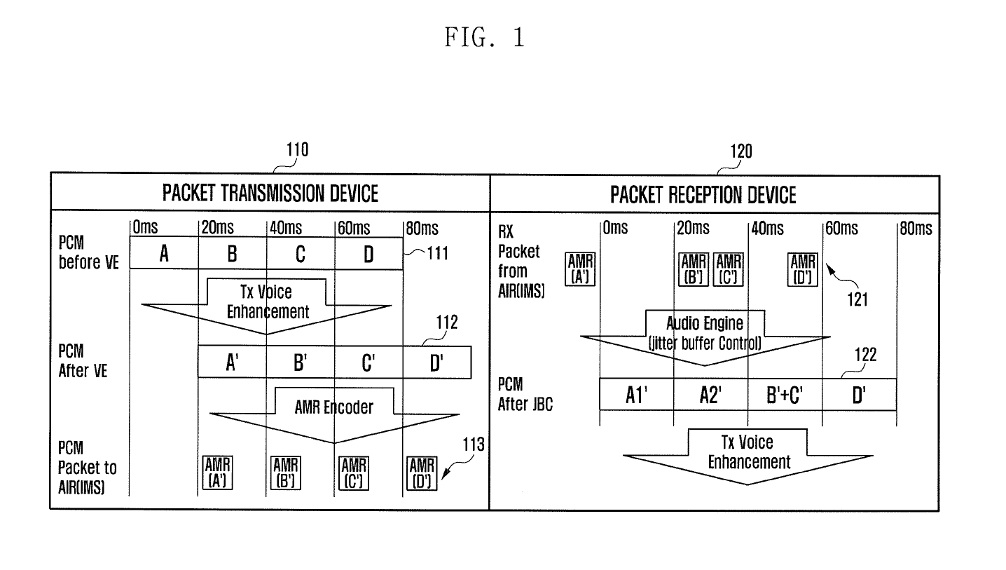

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunication technologies. Hereinafter, embodiments of the present disclosure will be described in more detail with reference to the accompanying drawings. In describing the embodiments, descriptions of technologies which are already known to those skilled in the art and are not directly related to the present disclosure may be omitted. Further, detailed descriptions of components having substantially the same configuration and function may be omitted. In the drawings, some components may be exaggerated, omitted, or schematically illustrated.

VoLTE is a voice communication technology for implementing VoIP in 3GPP LTE. An electronic device employing such VoLTE can perform voice communication based on a Real Time Transport Protocol (RTP) by using an adaptive multitransmission rate-wideband (AMR-WB) and adaptive multitransmission rate (AMR) encoder. In VoIP, Voice Quality Service (VOS) is important. Therefore, in a VoIP field, technology development for dynamic jitter buffering for processing an RTP packet and outputting smooth sound becomes important. Furthermore, through long-time experimental management for providing the best service according to network characteristics, a system configuration capable of providing the best VoLTE service can be set. In an IP network, factors having an influence on voice quality include packet delay, packet loss, jitter, a packet size and the like, and the voice quality is organically changed according to a change in the characteristics of the factors. Among the factors, factors having the largest influence on the voice quality are the jitter and the packet loss.

Packet delay due to a voice enhancement technique can occur in a packet transmission device. When such packet delay becomes long, QoS is degraded. Therefore, packet delay for voice processing should be minimized.

Factors having an influence on voice quality in the VoLTE and characteristics of the factors can be shown in Table 1 below.

TABLE 1

| QoS variable | Influence on communiation quality |
|---|---|
| Packet loss | Packet is lost during transmission |
| | Decoding is not possible |
| | Direct influence on voice quality |
| Delay | Output is temporally later than input |
| | Delay time of maximum 400 ms or less |
| Jitter | Variation of delay |
| | Caused by queuing delay and transmission path |
| | Jitter buffer is required - increase in entire delay |
| | If jitter is not stored in buffer, packet loss occurs |

The dynamic jitter buffering and the long-run test technique can have the following limitation in providing the best voice quality in a network environment being dynamically changed.
It does not provide a voice quality service coping with a network environment being organically changed.
Since it provides only a voice quality service by flexible processing of an RTP packet affected by a network environment after call setup between terminals, limited voice QoS is provided
It does not efficiently utilize a resource in terms of network management

FIG. 1 is a conceptual diagram for describing a packet recovery method according to an embodiment of the present disclosure.

Referring to FIG. 1, a packet transmission device 110 can perform Tx (transmission terminal) voice enhancement process on voice data 111 (A, B, C, and D) modulated in a pulse code modulation (PCM) scheme. The voice data 111 can be divided in units of predetermined times, for example, 20 ms as illustrated in FIG. 1. Furthermore, The Tx voice enhancement process, for example, can include an operation of reducing noise and removing echo in the voice data 111. Voice data 112, on which such a voice enhancement process has been performed, is delayed by 20 ms or more due to the process on example. The packet transmission device 110 can AMR-encode voice data 112 (A′, B′, C′, and D′), convert the encoded voice data into voice packets 113 (AMR (A′), AMR (B′), AMR (C′), and AMR (D′)), and transmit the voice packets 113 to a packet communication network (for example, the Internet). Such a packet communication network can include an IMS server.

The packet transmission device 110 can receive voice packets 121 (AMR (A′), AMR (B′), AMR (C′), and AMR (D′)) from the packet communication network, convert the received voice packets into voice data, and AMR-decode the voice data. A packet reception device 120 can perform jitter buffer control according to the embodiment of the present disclosure with respect to the decoded voice data. The jitter buffer control according to the embodiment of the present disclosure can include the following operations. When the reception of the AMR (B′) is delayed by a predetermined time (for example, 20 ms) or more from the time point at which the AMR (A′) has been received, the packet reception device 120, for example, can perform an operation of dividing the A′ into A1′ and A2′. Furthermore, when a plurality of voice packets (for example, AMR (B′) and AMR (C′)) are received in a predetermined time (for example, 20 ms), the packet reception device 120 can perform an operation of reducing the B′ and the C′ to B′+C′. The packet reception device 120 can perform an Rx voice enhancement process on decoded voice data 122 (A1′, A2′, B′+C′, and D′) and output the processed voice data to a voice output unit (for example, including a speaker, an earphone, or a receiver). The Rx voice enhancement process, for example, can include an operation of reducing noise and removing echo in the voice data 122. As described above, the packet reception device 120 performs the Rx voice enhancement process on the voice packet, but voice quality deterioration (that is, A′ is divided into A1′ and A2′ and B′ and C′ are reduced to B′+C′) due to network delay can occur.

Next, the packet recovery method according to the embodiment of the present disclosure will be described.

According to the packet recovery method according to the embodiment of the present disclosure, the packet transmission device can AMR-encode voice data at a high bit rate and a low bit rate. The packet transmission device can delay the voice data, which has been encoded at one (for example, the low bit rate) of the high bit rate and the low bit rate, by a predetermined time. The packet transmission device can synthesize current voice data encoded at the high bit rate with previous voice data delayed by a predetermined time and encoded at the low bit rate. The packet transmission device can convert the synthesized data into a voice packet, and transmit the voice packet to the packet communication network. In this case, the voice data encoded at the low bit rate can be utilized as additional information to be used in the packet reception device in order to recover a lost packet.

The packet reception device can receive the voice packet from the packet communication network, store the voice packet in a buffer, and determine whether the voice packet has been normally received. As a result of the determination, when loss (for example, a corresponding packet is delayed by 20 ms or more than a fixed time) occurs in one packet, the packet reception device can recover a lost packet by using the additional information. When loss occurs in consecutive two or more packets, the packet reception device recovers the lost first packet by using the additional information, and recovers the other packets by applying an interpolation method to a packet normally received in a previous time and the recovered first packet.

A packet recovery method according to another embodiment of the present disclosure can include an operation of giving additional delay by using an AMR-WB encoder such that realtime voice communication is possible in the packet communication network, adding additional information to existing data, and transmitting a packet, and an operation of performing forward error correction (FEC) for voice data by using the additional information when a received packet is lost. In such a recovery method, SNR and MOS are improved as a loss rate increases as illustrated in Table 2 below, but the following problems can occur.
When the recovery method are not provided in the packet transmission device and the packet reception device, mutual communication is not possible
In order to generate the additional information, delay of minimum 20 ms or more occurs in the packet transmission device

TABLE 2

| Mean loss rate | | 0% | 1% | 5% | 10% | 20% | 30% |
|---|---|---|---|---|---|---|---|
| AMR-WB 23.05 (kbit/s) | MOS | 4.260 | 3.928 | 3.472 | 3.112 | 2.495 | 2.205 |
| | SNR (dB) | 35.431 | 23.312 | 17.579 | 10.983 | 5.829 | 3.735 |
| Proposed method (15.85 + 6.60) | MOS | 4.179 | 4.067 | 3.870 | 3.650 | 3.267 | 3.036 |
| 22.45 (kbit/s) | SNR (dB) | 31.051 | 25.660 | 21.493 | 16.175 | 11.245 | 8.583 |
| Proposed method (14.25 + 8.85) | MOS | 4.145 | 4.047 | 3.871 | 3.673 | 3.338 | 3.106 |
| 23.10 (kbit/s) | SNR (dB) | 29.808 | 25.500 | 22.093 | 17.781 | 13.454 | 10.834 |

In table 2 above, the mean opinion score (MOS) is a medium variable used as a criterion for voice quality in a VoIP service. Subjective opinions of examiners joining in a voice quality test are averaged and converted into scores, and the degree of voice quality is classified into 1 (superior) to 5 (dissatisfactory) grades.

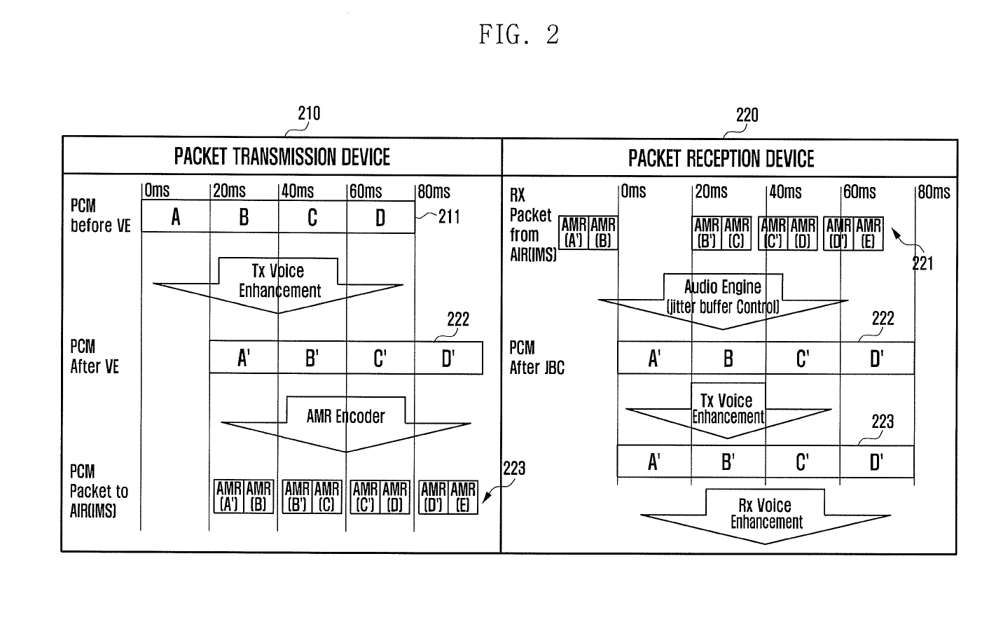

FIG. 2 is a conceptual diagram for describing a packet recovery method according to another embodiment of the present disclosure.

In a VoLTE communication environment, an IP multimedia subsystem (IMS) is used in order to provide a communication service of voice, audio, video, and other types of data based on an Internet protocol. In an actual communication environment, voice quality deterioration of VoLTE mainly occurs due to time delay in a network other than packet loss in an IMS network. According to the present disclosure, it is possible to overcome voice quality deterioration due to time delay in a network by using a time difference in a technique for transmission voice quality enhancement of voice data without additional time delay for voice processing.

Referring to FIG. 2, a packet transmission device 210 can perform a Tx voice enhancement process on voice data 211 (A, B, C, and D). The packet transmission device 210 can AMR-encode voice data 222 (A′, B′, C′, and D′) on which the Tx voice enhancement process has been performed. Furthermore, the packet transmission device 210 can AMR-encode the voice data 211 (A, B, C, and D) on which the Tx voice enhancement process has not been performed. Next, the packet transmission device 210 can synthesize previous encoded voice data, on which the Tx voice enhancement process has been performed, with current encoded voice data on which the Tx voice enhancement process has not been performed, thereby generating single voice data. In this case, it is noted that the ‘current’ and the ‘previous’ indicate only a relative time difference and do not indicate an absolute time. Then, the packet transmission device 210 can convert the synthesized data into voice packets 223 (AMR (A′) AMR (B), AMR (B′)AMR (C), AMR (C′)AMR (D), and AMR (D′)AMR (E)), and transmit the voice packets 223 to the packet communication network.

A packet reception device 220 can receive voice packets 221 (AMR (A′) AMR (B), AMR (B′)AMR (C), AMR (C′)AMR (D), and AMR (D′)AMR (E)) from the packet communication network. Next, the packet reception device 220 can convert the voice packets into synthesized data. Then, the packet reception device 220 can divide the synthesized data into voice data (the former) on which the Tx voice enhancement process has been performed, and voice data (the latter) on which the Tx voice enhancement process has not been performed, decode the former, and store the latter in a memory (for example, a buffer). At this time, the packet reception device 220 can perform jitter buffer control according to another embodiment of the present disclosure. The jitter buffer control according to another embodiment of the present disclosure can include the following operations. When the reception of the AMR (B′)AMR (C) is delayed by a predetermined time (for example, 20 ms) or more from the time point at which the AMR (A′)AMR (B) has been received, the packet reception device 220, for example, can perform an operation of reading the ‘B’ stored in the buffer, an operation of decoding the ‘B’, and an operation of performing the Tx voice enhancement process in order to convert the B to the B′. Then, the packet reception device 220 can perform an Rx voice enhancement process on voice data 223 (A′, B′, C′, and D′), and output the processed voice data to a voice output unit. According to the packet recovery method according to further another embodiment of the present disclosure, the packet reception device 220 can output voice data to the voice output unit without voice quality deterioration (that is, voice data is divided or reduced) due to network delay.

An electronic device to be described below can include the packet transmission/reception devices. Furthermore, the electronic device can include a computing device such as a smartphone, a camera, a tablet PC, a notebook PC, a desktop PC, a media player (for example, a MP3 player), a PDA, a game machine, or a wearable computer (for example, a watch, a glasses). Furthermore, the electronic device can also include a home appliance (for example, a refrigerator, a TV, a washing machine and the like) having a computing device therein.

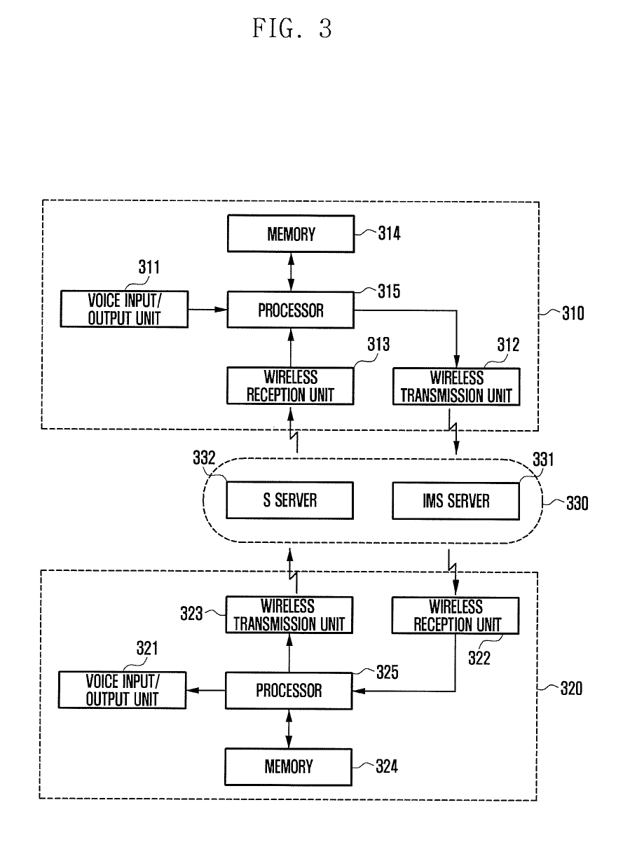

FIG. 3 is a network configuration diagram for describing a voice packet transmission/reception system according to an embodiment of the present disclosure.

Referring to FIG. 3, the voice packet transmission/reception system of the present disclosure can include a first electronic device 310, a second electronic device 320, and a packet communication network 330.

The first electronic device 310 can include a voice input/output unit 311, a wireless transmission unit 312, a wireless reception unit 313, a memory 314, and a processor 315. The voice input/output unit 311 can include a microphone, a speaker, a receiver, and an audio processing section. The audio processing section can receive an audio signal (for example, voice data) from the processor 315, D/A convert the received audio signal into an analog signal, amplify the analog signal, and output the amplified signal to a speaker. The audio processing section can be combined with a receiver and an earphone, and output an amplified signal to a receiver or an earphone other than the speaker. Furthermore, the audio processing section can A/D convert an audio signal received from a microphone or a microphone of an earphone into a digital signal (for example, voice data), and transfer the digital signal to the processor 315.

The wireless transmission unit 312 can convert voice data input from the processor 315 into an RF voice signal, and transmit the RF voice signal to the second electronic device 320 through the packet communication network 330. Furthermore, the wireless transmission unit 312 can transmit a request message related to a packet recovery method to the second electronic device 320 through the packet communication network 330. The wireless reception unit 313 can receive a response message related to the packet recovery method from the second electronic device 320 through the packet communication network 330, and transfer the response message to the processor 315. Furthermore, the wireless reception unit 313 can receive a voice packet from the second electronic device 320 through the packet communication network 330, and transfer the voice packet to the processor 315.

The memory 314 can store data generated according to the management of the first electronic device 310, or received from an external device through the wireless reception unit 313. Furthermore, the memory 314 can store various types of setup information (for example, a setup value related to the packet recovery method) for setting a use environment of the first electronic device 310. The processor 315 can manage the first electronic device 310 with reference to such setup information. Furthermore, the memory 314 can store various programs (for example, a booting program and one or more operating systems) for the management of the first electronic device 310, and various applications such as a memory application, a web browser, an e-book application, a camera application, a calendar application, a gallery application, a contact application, or a communication application. Furthermore, the memory 314 can store a voice data processing program set to allow the processor 315 to perform a process of processing voice data input from the voice input/output unit 311 to a voice packet and transferring the voice packet to the wireless transmission unit 312, and a voice packet processing program set to allow the processor 315 to perform a process of processing a voice packet received from the wireless reception unit 313 to voice data and transferring the voice data to the voice input/output unit 311. Such voice data/voice packet processing programs can be a partial configuration of an operating system or a separate application. Furthermore, the voice data/voice packet processing programs can also be firmware that is embedded in the processor 315, particularly, an internal memory (for example, a ROM, a flash memory, or an EPROM) of an application processor, and allows the application processor to perform the operation.

The memory 314 can include a main memory and a secondary memory. The main memory, for example, can be implemented as a RAM and the like. The secondary memory can be implemented as a disk, a RAM, a ROM, or a flash memory. The main memory can store various programs (for example, a booting program, an operating system, and applications) loaded from the secondary memory. When power of a battery is supplied to the processor 315, a booting program can be first loaded to the main memory. Such a booting program can load an operating system to the main memory. The operating system can load an application to the main memory. The processor 315 (for example, an application processor (AP)) can access the main memory, interpret a command (a routine) of a program, and perform a function according to an interpretation result. That is, various programs can be loaded to the main memory and operate as processes.

The processor 315 can control the general operation of the first electronic device 310 and a signal flow among the internal elements of the first electronic device 310, perform a function of processing data, and control the supply of power from the battery to the elements. The processor 315 can include an application processor (AP). The application processor can execute various programs stored in the memory 314. That is, the application processor can load the various programs from the secondary memory to the main memory and manage the various programs as processes. Particularly, the application processor can execute the voice data/voice packet processing programs as processes. Furthermore, the application processor can also process (that is, multiprocess) the programs at the same time.

The processor 315 can also further include various processors other than the application processor. For example, when the first electronic device 310 includes a mobile communication module (for example, a 3-generation mobile communication module, a 3.5-generation mobile communication module, a 4-generation mobile communication module and the like), the processor 315 can also further include a communication processor (CP) that takes charge of processing of mobile communication. The aforementioned processors can be integrated into one package in which two or more independent cores (for example, a quad-core) are prepared in the form of a single integrated circuit. For example, the application processor can be a processor integrated into one multicore processor. The aforementioned processors can be a processor integrated into one chip (SoC; system on chip). Furthermore, the aforementioned processors can be a processor packaged into a multilayer.

The second electronic device 320 can include a voice input/output unit 321, a wireless reception unit 322, a wireless transmission unit 323, a memory 324, and a processor 325. These elements 321 to 325 can perform the same operations as those of the elements of the aforementioned first electronic device 310. However, the second electronic device 320 can be classified into a type different from that of the first electronic device 310. For example, the first electronic device 310 can be classified into a smart phone and the second electronic device 320 can be classified into a tablet PC. It is of course that electronic devices can also be classified into the same type. Furthermore, the electronic devices can be classified into the same type, but can differ in performance. For example, all the first electronic device 310 and the second electronic device 320 can be classified into smart phones, but the second electronic device 320 can have a screen larger than that of the first electronic device 310. Furthermore, a processing speed of a processor of the second electronic device 320 can be faster than that of the first electronic device 310. Furthermore, the electronic devices can have elements different from one another. For example, the first electronic device 310 can have a near field communication (NFC) module, but the second electronic device 320 may not have the NFC module. Furthermore, the electronic devices can also differ in a platform (for example, firmware, an operating system and the like).

The second electronic device 320 can perform voice communication with the first electronic device 310 through call setup with the first electronic device 310. In this case, as well-known in the art, the call setup can include a series of procedures for processing the setup of communication lines among terminals, which include an address ID required for an originating terminal of a packet communication network, path selection through a network, connection permission to a reception terminal, and the like.

The packet communication network 330 can include an IMS server 331 and an S server 332. A voice packet can be transferred from a packet transmission device to a packet reception device through the IMS server 331. The S server 332 can perform an operation of confirming whether the both terminals 310 and 320 have the same VoLTE function. For example, the S server 332 can receive a “request message that inquires whether a packet processing scheme corresponding to the voice data processing scheme of FIG. 2 exists in the second electronic device 320” from the first electronic device 310, and transfer the request message to the second electronic device 320. The S server 332 can receive a response message related to the request message from the second electronic device 320, and transfer the response message to the first electronic device 310. Furthermore, the S server 332 can also perform an operation of transferring a parameter of a Tx voice enhancement processing scheme of a packet transmission device (for example, the first electronic device 310) to a packet reception device (for example, the second electronic device 320). Furthermore, in response to the request of the packet reception device (for example, the second electronic device 320), the S server 332 can also perform an operation of transferring a message for requesting a change in a voice data processing scheme to the packet transmission device (for example, the first electronic device 310).

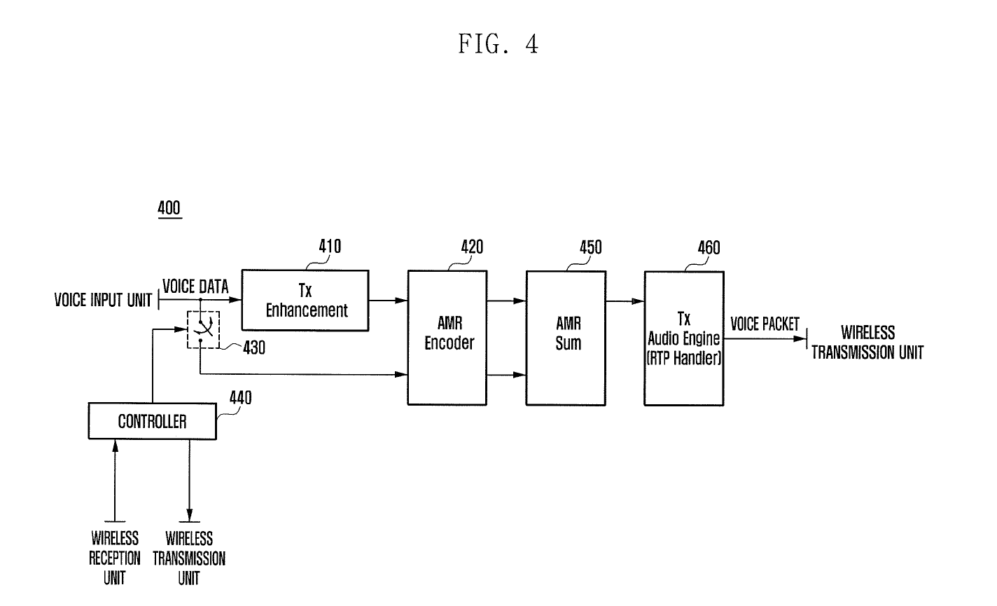

FIG. 4 is a detailed block configuration diagram for voice data processing of a processor according to an embodiment of the present disclosure.

Referring to FIG. 4, a Tx voice enhancement processing unit 410 performs a Tx voice enhancement process on voice data input from a voice input unit, and transfers the processed data to an encoder 420. The encoder 420 AMR-encodes the voice data input from the Tx voice enhancement processing unit 410 and voice data directly input from the voice input unit. A switch 430 switches the input of voice data from the voice input unit to the encoder 420. A controller 440 controls the switching operation of the switch 430. For example, in response to an “ON” signal received from a wireless reception unit, the controller 440 can control the switch 430 such that voice data is directly input to the encoder 420. Furthermore, in response to an “OFF signal received from the wireless reception unit, the controller 440 can control the switch 430 such that voice data is prevented from being directly input to the encoder 420. Furthermore, the controller 440 can receive a message for requesting information (for example, a parameter for a Tx voice enhancement process) related to voice data processing of its own processor from the wireless reception unit, and transfer the corresponding information to a wireless transmission unit in response to such a request message. A data synthesizing unit 430 can simultaneously receive “encoded voice data on which a Tx voice enhancement process has been performed” and “encoded voice data on which the Tx voice enhancement process has not been performed” from the encoder 420, synthesize the two types of voice data into single voice data, and transfer the single voice data to a packet conversion unit 460. When only the “encoded voice data on which the Tx voice enhancement process has been performed” is received, the data synthesizing unit 430 can transfer the received voice data to the packet conversion unit 460 as is. The packet conversion unit 460 can convert the synthesized data received from the data synthesizing unit 430 or the “encoded voice data on which the Tx voice enhancement process has been performed” into a voice packet, and transfer the voice packet to a wireless communication unit (e.g., transceiver).

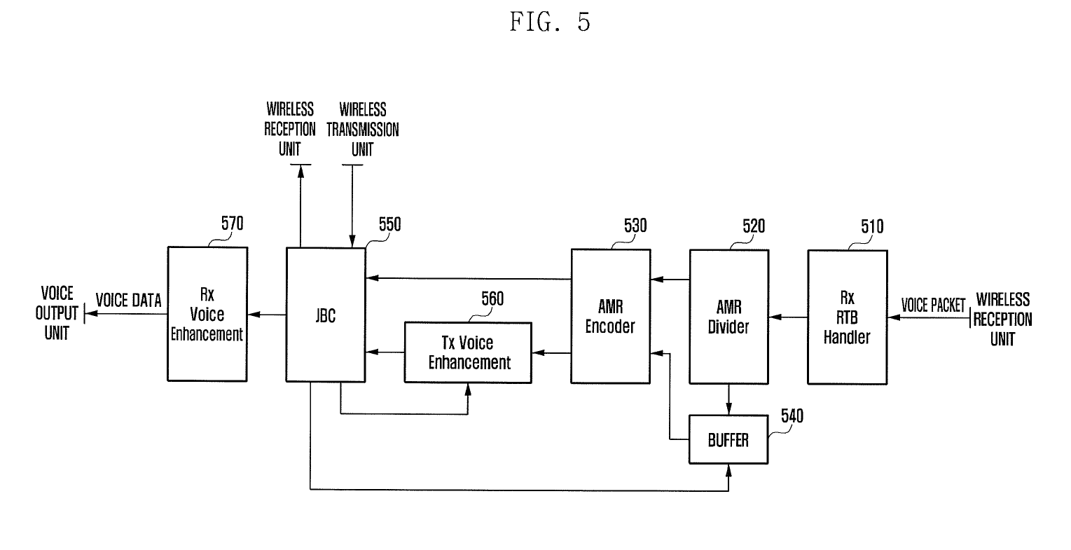

FIG. 5 is a detailed block configuration diagram for voice packet processing of a processor according to an embodiment of the present disclosure.

Referring to FIG. 5, a voice data conversion unit 510 converts a voice packet received from a wireless reception unit into voice data and transfers the voice data to a data divider 520. The data divider 520 determines whether the voice data received from the voice data conversion unit 510 is synthesized data. For example, the data divider 520 can inspect header information of the received voice data and recognize whether the received voice data is synthesized data. When the received data is recognized as the synthesized data, the data divider 520 can divide the received data into voice data (hereinafter, the former) on which a Tx voice enhancement process has been performed, and voice data (hereinafter, the latter) on which the Tx voice enhancement process has not been performed. For example, the data divider 520 can inspect the header information of the received voice data and recognize a part of the received voice data, which corresponds to the former, and a part of the received voice data, which corresponds to the latter. When the recognition is completed, the data divider 520 transfers the former of the synthesized data to a decoder 530 and transfers the latter to a buffer 540. In this case, the number of the voice data that is stored in the buffer 540 can be limited, and when the limited number is exceeded, the first stored data can be first deleted. Furthermore, the buffer 540 can transfer stored data (for example, the last stored data) to the decoder 530 in response to the request of a controller 550, and then reset (that is, delete all) the stored data. When the received data is not the synthesized data, the data divider 520 transfers the received voice data to the decoder 530.

The decoder 530 AMR-decodes the voice data received from the data divider 520 and transfers the decoded data to the controller 550. Furthermore, the decoder 530 can decode the voice data received from the buffer 540 and transfer the decoded data to a Tx voice enhancement processing unit 560. The Tx voice enhancement processing unit 560 can perform a Tx voice enhancement process on the voice data received from the decoder 530, similarly to the Tx voice enhancement processing unit 410, and transfer the processed data to the controller 550.

The controller 550 transfers the voice data received from the decoder 530 or the Tx voice enhancement processing unit 560 to an Rx voice enhancement processing unit 570. Furthermore, the controller 550 can perform the jitter buffer control described with reference to FIG. 2. That is, when there is no data received from the decoder 530 for a predetermined time (for example, 20 ms), the controller 550 controls the buffer 540 to output the stored voice data to the decoder 530. Furthermore, the controller 550 can receive a “request message that inquires whether a packet processing scheme corresponding to the voice data processing scheme of FIG. 2 exists in its own device” from the wireless reception unit, and control a wireless transmission unit to transmit information indicating “presence” in response to the request message. Furthermore, the controller 550 can receive a parameter of the Tx voice enhancement process scheme from the wireless reception unit, and control the Tx voice enhancement processing unit 560 to perform the Tx voice enhancement process based on the parameter. Furthermore, the controller 550 can inspect the degree of delay of data reception from the decoder 530, and control the wireless transmission unit to transmit a “message for requesting a change in a voice data processing scheme” based on such inspection information.

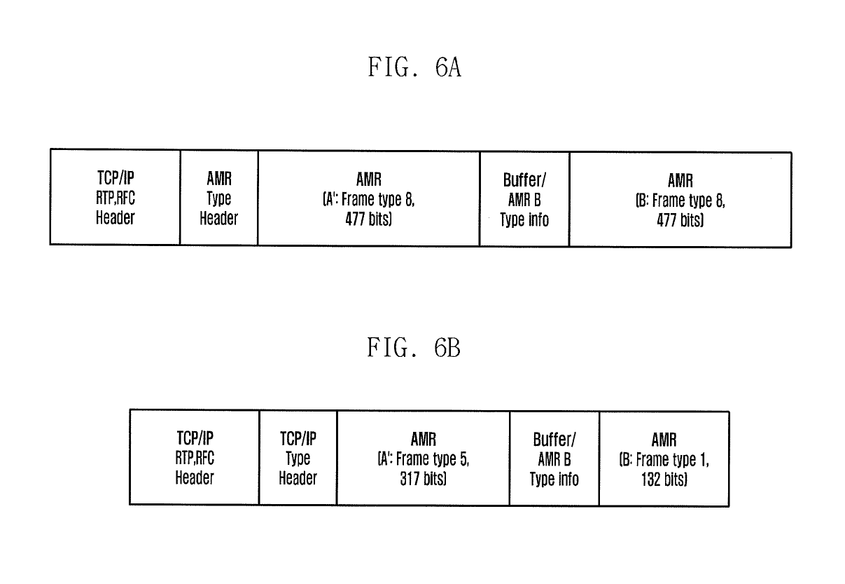

FIGS. 6A and 6B are diagrams illustrating configurations of voice packets according to embodiments of the present disclosure. When a corresponding packet communication network permits that a bandwidth (BW) of a voice packet exceeds a reference value defined in the standard of the VoLTE, the packet transmission device can generate a voice packet with a size illustrated in FIG. 6A. When the corresponding packet communication network does not permit it, the packet transmission device can generate a voice packet with a size illustrated in FIG. 6B. In FIGS. 6A and 6B, an “AMR Type Header” can include information related to “voice data on which the Tx voice enhancement process has not been performed”.

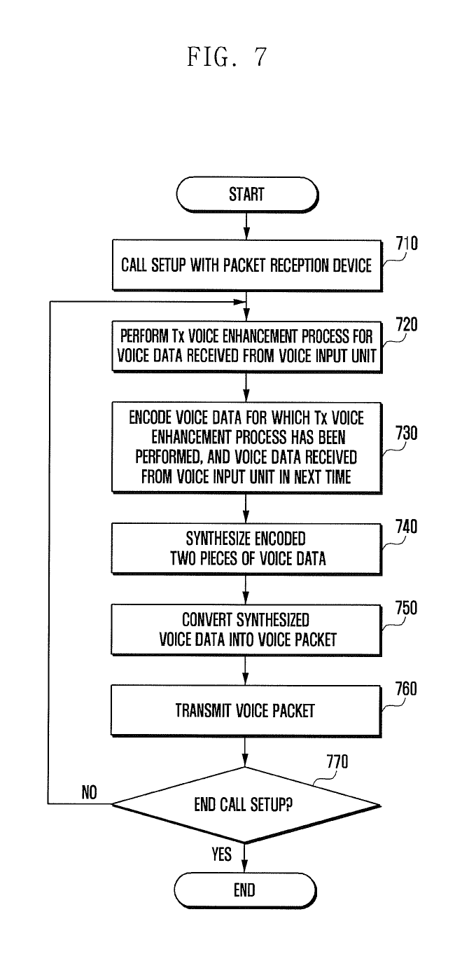

FIG. 7 is a flowchart for describing a voice data processing method of the packet transmission device according to an embodiment of the present disclosure.

Referring to FIG. 7, in an operation 710, a processor 400 of the packet transmission device can control a wireless transmission unit and a wireless reception unit (hereinafter, referred to as a wireless communication unit) to perform call setup with the packet reception device. In an operation 720, the processor 400 can perform the Tx voice enhancement process on the voice data received from the voice input unit (e.g., a microphone). In an operation 730, the processor 400 can encode the voice data on which the Tx voice enhancement process has been performed, and voice data received from the voice input unit in a next time, respectively. In an operation 740, the processor 400 can synthesize the encoded two pieces of voice data into single voice data. In an operation 750, the processor 400 can convert the synthesized voice data into a voice packet. In an operation 760, the processor 400 can control the wireless communication unit to transmit the voice packet. In an operation 770, the processor 400 can determine whether to end the call setup. When the call setup is ended (for example, when a user taps a communication end button displayed on a touchscreen, the touchscreen detects this and transfers it to the processor 400, and the processor 400 recognizes the request of communication end), the process of FIG. 7 is ended, and otherwise, the process can return to the operation 720.

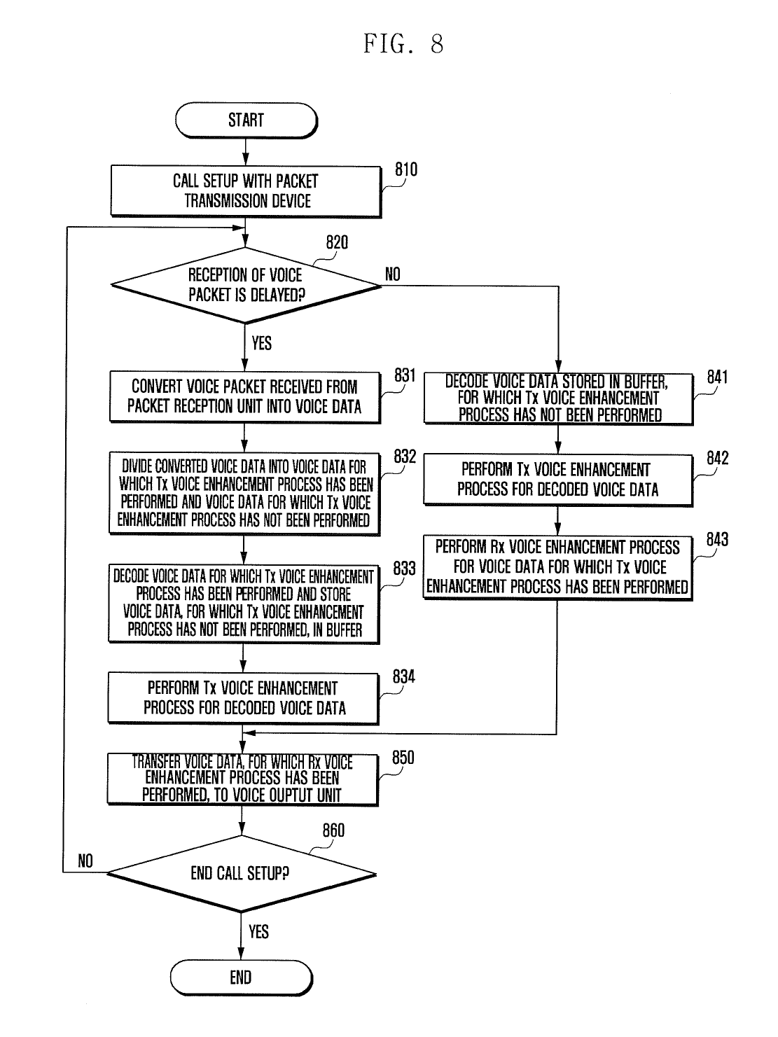

FIG. 8 is a flowchart for describing a voice packet processing method of the packet reception device according to an embodiment of the present disclosure.

Referring to FIG. 8, in an operation 810, a processor 500 of the packet reception device can control the wireless communication unit to perform call setup with the packet transmission device. In an operation 820, the processor 500 can determine whether the reception of a voice packet is delayed for a predetermined time (for example, 20 ms) or more. When the reception of the voice packet is not delayed, the processor 500 can convert a voice packet received from a packet reception unit into voice data in an operation 831. In an operation 832, the processor 500 can divide the converted voice data into voice data on which the Tx voice enhancement process has been performed and voice data on which the Tx voice enhancement process has not been performed. In an operation 833, the processor 500 can decode the voice data on which the Tx voice enhancement process has been performed and store the voice data, on which the Tx voice enhancement process has not been performed, in a buffer. In an operation 834, the processor 500 can perform the Rx voice enhancement process on the decoded voice data. After the operation 834 is performed, the process can proceed to an operation 850.

As a result of the determination of the operation 820, when the reception of the voice packet is delayed, the processor 500 can decode the voice data stored in the buffer, on which the Tx voice enhancement process has not been performed, in an operation 841. In an operation 842, the processor 500 can perform the Tx voice enhancement process on the decoded voice data. In an operation 843, the processor 500 can perform the Rx voice enhancement process on the voice data on which the Tx voice enhancement process has been performed. After the operation 843 is performed, the process can proceed to the operation 850.

In the operation 850, the processor 500 can transfer the voice data, on which the Rx voice enhancement process has been performed, to the voice output unit (e.g., a speaker). In an operation 860, the processor 500 can determine whether to end the call setup. When the call setup is ended, the process of FIG. 8 is ended, and otherwise, the process can return to the operation 820.

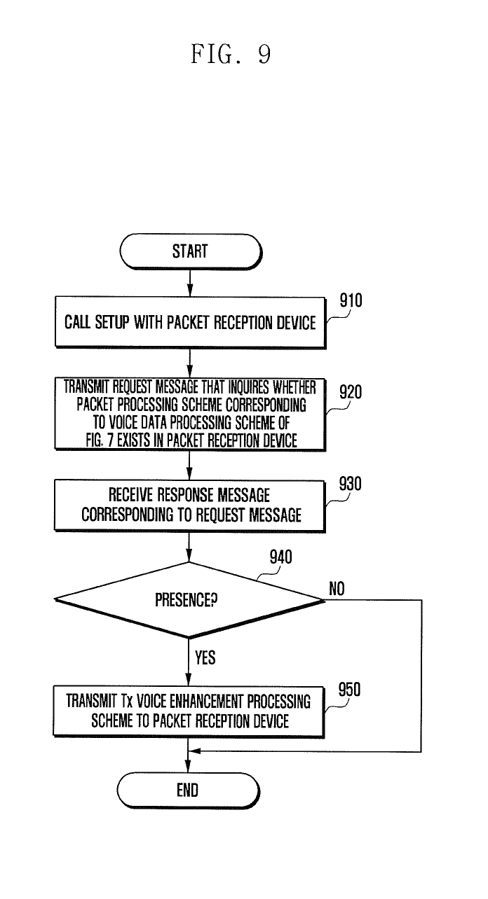

FIG. 9 is a flowchart for describing a synchronization method of the TX voice enhancement processing scheme among communication terminals according to an embodiment of the present disclosure.

Referring to FIG. 9, in an operation 910, the processor 400 of the packet transmission device can control the wireless communication unit to perform call setup with the packet reception device. In an operation 920, the processor 400 can control the wireless communication unit to transmit a request message that inquires whether a packet processing scheme corresponding to the voice data processing scheme of FIG. 7 exists in the packet reception device. In an operation 930, the processor 400 can receive a response message corresponding to the request message from the wireless reception device through the wireless communication unit. In an operation 940, the processor 400 can determine whether information indicating “presence” is included in the response message. As a result of the determination, when the information indicating “presence” is included in the response message, the processor 400 can control the wireless communication unit to transmit information related to the TX voice enhancement processing scheme to the packet reception device, in an operation 950.

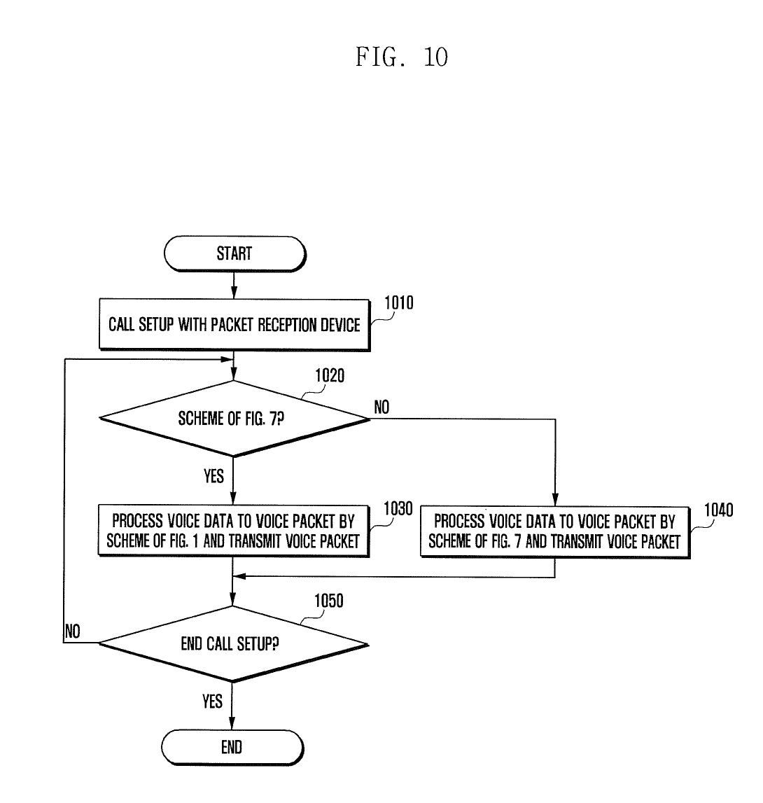

FIG. 10 is a flowchart for describing a voice data processing method of the packet transmission device according to another embodiment of the present disclosure.

Referring to FIG. 10, in an operation 1010, the processor 400 of the packet transmission device can control the wireless communication unit to perform call setup with the packet reception device. In an operation 1020, the processor 400 can determine whether to process voice data by the scheme of FIG. 7. For example, when the packet reception device has requested the scheme of FIG. 7, the processor 400 can determine to process the voice data by the scheme of FIG. 7, and when the packet reception device has requested the scheme of FIG. 1, the processor 400 can determine to process the voice data by the scheme of FIG. 1.

As a result of the determination in the operation 1020, when it is determined to process the voice data by the scheme of FIG. 1, the processor 400 can process the voice data to a voice packet by the scheme of FIG. 1, and control the wireless communication unit to transmit the voice packet, in an operation 1030. As a result of the determination in the operation 1020, when it is determined to process the voice data by the scheme of FIG. 7, the processor 400 can process the voice data to a voice packet by the scheme of FIG. 7, and control the wireless communication unit to transmit the voice packet, in an operation 1040.

In an operation 1050, the processor 400 can determine whether to end the call setup. When the call setup is ended, the process of FIG. 10 is ended, and otherwise, the process can return to the operation 1020.

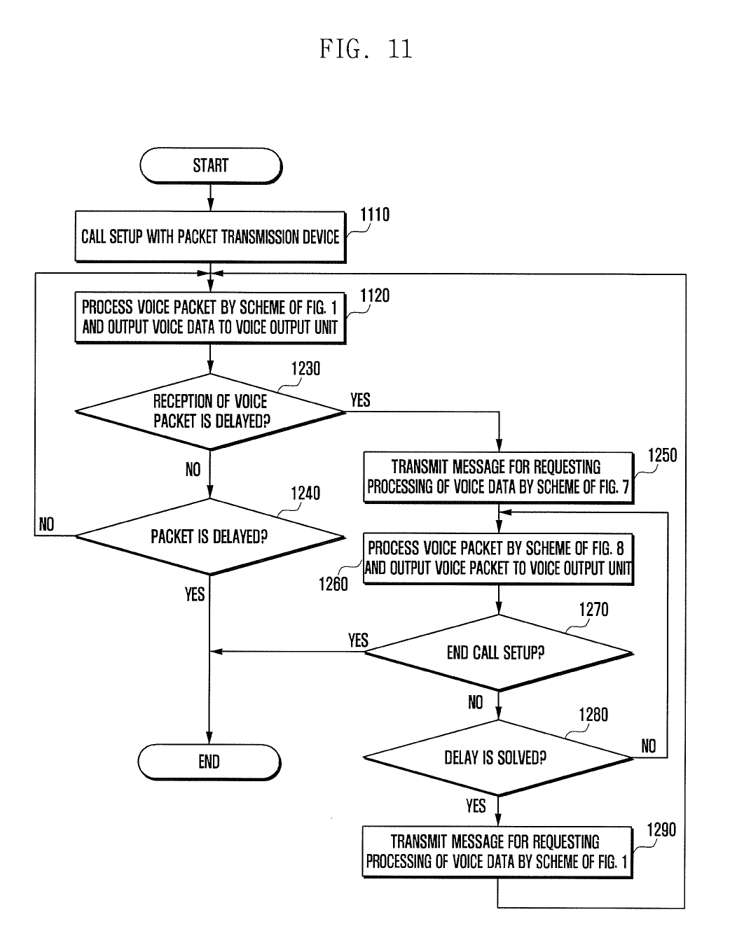

FIG. 11 is a flowchart for describing a voice packet processing method of the packet reception device according to another embodiment of the present disclosure.

Referring to FIG. 11, in an operation 1110, the processor 500 of the packet reception device can control the wireless communication unit to perform call setup with the packet transmission device. In an operation 1120, the processor 500 can process a voice packet to voice data by the scheme of FIG. 1 and output the voice data to the voice output unit.

In an operation 1230, the processor 500 can determine whether the reception of a voice packet is delayed for a predetermined time (for example, 20 ms). Alternatively, in the operation 1230, the processor 500 can also determine whether the number of times of delay is equal to or more than a preset threshold value for a predetermined time (for example, one second).

As a result of the determination in the operation 1230, when the reception of the voice packet is not delayed or the number of times of delay is equal to or less than the threshold value, the processor 500 can determine whether to end the call setup in an operation 1240. When the call setup is ended, the process of FIG. 11 is ended, and otherwise, the process can return to the operation 1120.

As a result of the determination in the operation 1230, when the reception of the voice packet is delayed or the number of times of delay is smaller than the threshold value, the processor 500 can control the wireless communication unit to transmit a message for requesting the processing of voice data by the scheme of FIG. 7 in an operation 1250. In an operation 1260, the processor 500 can process a voice packet by the scheme of FIG. 8 and output the processed voice packet to the voice output unit. In an operation 1270, the processor 500 can determine whether to end the call setup. When the call setup is ended, the process of FIG. 11 is ended, and otherwise, the processor 500 can determine whether delay is solved (that is, the reception of a voice packet is delayed for a predetermined time or the number of times of delay is equal to or more than a preset threshold value for a predetermined time) in an operation 1280.

As a result of the determination in the operation 1280, when the delay is solved (that is, the reception of the voice packet is not delayed or the number of times of delay is equal to or less than the threshold value), the processor 500 can control the wireless communication unit to transmit a message for requesting the processing of voice data by the scheme of FIG. 1 in an operation 1290. As a result of the determination in the operation 1280, when the delay is not solved, the process can return to the operation 1260.

The method according to the present disclosure as described above can be implemented as a program command which can be executed through various computers and recorded in a computer-readable recording medium. The program command can be specially designed and configured for the present disclosure or can be used after being known to those skilled in computer software fields. The recording medium can include magnetic media such as a hard disk, a floppy disk and a magnetic tape, optical media such as a Compact Disc Read-Only Memory (CD-ROM) and a Digital Versatile Disc (DVD), magneto-optical media such as a floptical disk, and hardware devices such as a Read-Only Memory (ROM), a Random Access Memory (RAM) and a flash memory. Further, the program command can include a machine language code generated by a compiler and a high-level language code executable by a computer through an interpreter and the like.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting a voice packet in an electronic device, the method comprising:
setting a call with another electronic device;
performing a Tx voice enhancement process on first voice data received from a voice input unit;
encoding the first voice data, and second voice data received from the voice input unit, following the first voice data;
synthesizing the first voice data and the second data; and
converting the synthesized voice data into a voice packet and transmitting the voice packet to another electronic device.

2. The method of claim 1, further comprising:
transmitting a request message inquiring whether a predetermined packet processing scheme exists in the other electronic device, to the other electronic device after a call with the other electronic device is set; and
transmitting information related to the Tx voice enhancement process to the other electronic device when a response message indicating that the predetermined packet processing scheme exists in the other electronic device, is received.

3. The method of claim 2, wherein, when a message for requesting a change in a voice data processing scheme is received from the other electronic device,
the electronic device stops the encoding operation, the synthesizing operation, and the first transmission operation and encodes the first voice data in a second encoding operation, converts the voice data encoded by the second encoding operation into a voice packet, and transmits the voice packet to the other electronic device.

4. The method of claim 1, wherein the Tx voice enhancement process comprises:
performing at least one of reducing noise from the voice data received from the voice input unit and removing echo from the voice data received from the voice input unit.

5. A method for processing a voice packet in an electronic device, the method comprising:
converting a first voice packet received from another electronic device into voice data;
dividing the converted voice data into first voice data on which a Tx voice enhancement process has been performed, and second voice data on which the Tx voice enhancement process has not been performed;
decoding the first voice data and storing the second voice data in a buffer;
outputting the decoded first voice data to a voice output unit; and
outputting the second voice data stored in the buffer to the voice output unit when reception of a second voice packet is delayed after the first voice packet is received.

6. The method of claim 5, wherein outputting the second voice data comprises:
performing the Tx voice enhancement process on the second voice data stored in the buffer; and
outputting the second voice data, on which the Tx voice enhancement process has been performed, to the voice output unit.

7. The method of claim 6, wherein the Tx voice enhancement process is performed based on information received from the other electronic device.

8. The method of claim 5, wherein outputting the decoded first voice data comprises:
performing an Rx voice enhancement process on the decoded first voice data and outputting the first voice data to the voice output unit.

9. An electronic device for transmitting and receiving a voice packet, comprising:
a voice input/output unit;
a wireless communication unit configured to transmit or receive a voice packet; and
a processor configured to:
perform a Tx voice enhancement process on first voice data received from the voice input/output unit;
encode the first voice data, and second voice data received from the voice input/output unit, following the first data;
synthesize the encoded first voice data and the encoded second voice data;
control the wireless communication unit to convert the synthesized voice data into a voice packet and transmit the voice packet to another electronic device;
convert a first voice packet received from the wireless communication unit into voice data;
divide the converted voice data into first voice data on which a Tx voice enhancement process has been performed, and second voice data on which the Tx voice enhancement process has not been performed;
decode the first voice data and storing the second voice data in a buffer;
output the decoded first voice data to the voice input/output unit; and
output the second voice data stored in the buffer to the voice input/output unit when reception of a second voice packet is delayed after the first voice packet is received.

10. The electronic device of claim 9, wherein the processor is configured to:
transmit a request message inquiring whether a predetermined packet processing scheme exists in the other electronic device, to the other electronic device after a call with the other electronic device is set, and
control the wireless communication unit to transmit information related to the Tx voice enhancement process to the other electronic device when a response message indicating that the predetermined packet processing scheme exists in the other electronic device, is received from the wireless communication unit.

11. The electronic device of claim 10, wherein, when a message for requesting a change in a voice data processing scheme is received from the wireless communication unit, the processor is configured to stop the encoding, synthesizing, and transmitting operations, and encode the first voice data in a second encoding operation, and control the wireless communication unit to convert the voice data encoded by the second encoding operation into a voice packet and transmit the voice packet to the other electronic device.

12. The electronic device of claim 11, wherein the processor is configured to performs the Tx voice enhancement process comprising at least one of reducing noise from the voice data received from the voice input/output unit and remove echo from the voice data received from the voice input/output unit.

13. The electronic device of claim 9, wherein the processor is configured to perform the Tx voice enhancement process on the second voice data stored in the buffer, and output the second voice data, on which the Tx voice enhancement process has been performed, to the voice input/output unit.

14. The electronic device of claim 13, wherein the processor is configured to perform the Tx voice enhancement process, based on information received from the other electronic device.

15. The electronic device of claim 9, wherein the processor is configured to perform an Rx voice enhancement process on the decoded first voice data and output the first voice data to the voice input/output unit.

16. An electronic device for transmitting a voice packet, comprising:
a voice input/output unit;
a wireless communication unit configured to transmit or receive a voice packet; and
a processor configured to:
perform a Tx voice enhancement process on first voice data received from the voice input/output unit;
encode the first voice data, and second voice data received from the voice input/output unit, following the first data;
synthesize the encoded first voice data and the encoded second voice data; and
control the wireless communication unit to convert the synthesized voice data into a voice packet and transmit the voice packet to another electronic device.

17. The electronic device of claim 16, wherein the processor is configured to performs the Tx voice enhancement process comprising at least one of reducing noise from the voice data received from the voice input/output unit and remove echo from the voice data received from the voice input/output unit.

18. An electronic device for receiving a voice packet, comprising:
a voice input/output unit;
a wireless communication unit configured to transmit or receive a voice packet; and
a processor configured to:
convert a first voice packet received from the wireless communication unit into voice data;
divide the converted voice data into first voice data on which a Tx voice enhancement process has been performed, and second voice data on which the Tx voice enhancement process has not been performed;
decode the first voice data and storing the second voice data in a buffer;
output the decoded first voice data to the voice input/output unit; and
output the second voice data stored in the buffer to the voice input/output unit when reception of a second voice packet is delayed after the first voice packet is received.

19. The electronic device of claim 18, wherein the processor is configured to performs the Tx voice enhancement process comprising at least one of reducing noise from the voice data received from the voice input/output unit and remove echo from the voice data received from the voice input/output unit.

20. The electronic device of claim 19, wherein the processor is configured to perform the Tx voice enhancement process, based on information received from the other electronic device.
